(19) United States
(12) Patent Application Publication
(10) Pub. No.: US 2013/0262698 A1
(43) Pub. Date: Oct. 3, 2013

(54) METHOD AND ROUTER FOR SERVICE NAMED ROUTING

(71) Applicants: Nico Schwan, Stuttgart (DE); Shashank Shanbhag, Campbell, CA (US)

(72) Inventors: Nico Schwan, Stuttgart (DE); Shashank Shanbhag, Campbell, CA (US)

(73) Assignee: ALCATEL-LUCENT, Paris (FR)

(21) Appl. No.: 13/883,134

(22) PCT Filed: Sep. 26, 2011
(86) PCT No.: PCT/EP2011/066640

§ 371 Date: Jun. 19, 2013

(30) Foreign Application Priority Data
Dec. 17, 2010 (EP) 10290663.3

(51) Int. Cl. H04L 12/56

(52) U.S. Cl. CPC H04L 45/54
USPC 709/242

(57) ABSTRACT

A first router sends to neighboring routers an interest packet associated with the at least one service including a service name indicator and a unique interest tag. A second router receives the interest packet, sends the interest packet to a server of the at least two servers and stores the interest tag together with the incoming and outgoing connection port in its interest route table. The server attaches data including load data of the at least one service to the interest packet and sends the interest packet back to the second router. The second router calculates service performance data based on the data attached, stores the service performance data in its service performance table and updates the routing table based on an evaluation of the service performance data, and sends the interest packet via its incoming connection port as associated by the interest route table to the first router.

The present invention relates to a method and a router for service named routing in a packet based communication network. The communication network comprises at least two servers providing at least one service and a plurality of routers.

Current Internet architecture relies on network addresses and host identities through URLs (URL=Uniform Resource Locator) to locate content. Locating content is primarily based on resolution of host identities into a network address, i.e. IP addresses (IP=Internet Protocol), followed by the actual retrieval of content using the network address. Today various balancing systems are built on top of the IP layer in order to redirect nodes to the closest content and/or the service, i.e. to access the content and/or the service, respectively. However, IP addressed based routing does not provide a highly flexible and scalable approach for service provision when the shortest route to the server is a minor criteria. For example, compute intensive services may require much more computing time for provisioning service than the time required for communication packet and/or data packet transport through the communication network from the server to the client.

It is an object of the invention to provide an improved method for service named routing in a packet based communication network. It is also an object of the invention to provide an improved router for service named routing in a packet based communication network.

The object of the present invention is achieved by a method for service named routing in a packet based communication network, the communication network comprises at least two servers providing at least one service and a plurality of routers, wherein each router of the plurality of routers provides a routing table, a service performance table and an interest route table, each router stores in its routing table for each service of the at least one service at least one connection port associated with the at least one service, each router stores in its service performance table for each service of the at least one service service performance data associated with two or more connection ports of the router, a first router of the plurality of routers sends to two or more neighboring routers via two or more of its connection ports an interest packet associated with the at least one service comprising a service name indicator and a unique interest tag, a second router of the plurality of routers receives the interest packet via an incoming connection port, sends the interest packet via an outgoing connection port associated with the at least one service in its routing table and stores the interest tag of the received interest packet together with the incoming connection port and the outgoing connection port in its interest route table, a server of the at least two servers receives the interest packet, the server attaches data comprising load data of the at least one service to the interest packet and sends the interest packet back to the second router, the second router receives the interest packet, and the second router calculates service performance data based on the data attached to the interest packet, stores the service performance data in the service performance table of the second router, updates the routing table of the second router based on an evaluation of the service performance data stored in the service performance table of the second router and sends the interest packet via the incoming connection port as associated by the interest route table to the first router. The object of the present invention is also achieved by a router for service named routing in a packet based communication network comprising at least two servers providing at least one service and a plurality of routers, wherein the router comprises at least one storage unit storing a routing table, a service performance table which stores for each service of the at least one service service performance data associated with two or more connection ports of the router and an interest route table, a network interface comprising two or more connection ports and a control unit adapted to receive an interest packet, which was sent by another router of the plurality of routers, associated with the at least one service comprising a service name indicator and a unique interest tag via an incoming connection port, send the interest packet via an outgoing connection port associated with the at least one service in the routing table and store the interest tag of the received interest packet together with the incoming connection port and the outgoing connection port in the interest route table, to receive the interest packet comprising data, which comprises a load data of the at least one service, attached to the interest packet by a server of the at least two servers via the outgoing connection port associated with the interest tag stored in the interest route table, to calculate service performance data based on the data attached to the interest packet, store the service performance data in the service performance table and update the routing table based on an evaluation of the service performance data stored in the service performance table, and to send the interest packet via the incoming connection port as associated by the interest route table to the other router.

The present invention provides a surprisingly effective way to access and/or provide services, for instants to clients by servers. A service provided by a server may also comprise content provision. Embodiments according to the present invention provide to route on content identities than network addresses, i.e. the determination of the routing path is made based on content and/or service identities.

The invention provides a more efficient networking approach, since it reduces the number of indirections, and allows the incorporation of services like multicasting and QoS (QoS=Quality of Service) while ensuring secure delivery of content. The present invention provides CCN (CCN=Content Centric Networking). The NBR layer (NBR=name based routing) of these communication networks delivers the closest copy of a certain content item and/or service to the requesting client. Close in this case means shortest is latency, which is usually also reflected by a minimized hop-count that the content has to be transmitted.

Embodiments of the invention are applicable to, preferably compute intensive, services, like transcoding of video and/or audio data, but not limited and are also suitable for content provision.

Embodiments of the present invention are similar to ACO techniques (ACO=Ant Colony Optimization) and may be based on ACO in combination with NBR to allow more accurate routing decisions in the routing layer. Additional information, such as load data of the service or available bandwidth on the routing path data, is gathered to make these decisions. In particular, separating this decision from the actual forwarding plane by modifying routing tables in the router may be achieved. Therefore, it is possible that the routing is still done in line speed. Such, the present invention is superior to today's IP based load-balancing systems and today's NBR layers.

Embodiments of the present invention overcome state of the art load balancing mechanisms, e.g. for cloud centralized implementations services, design limitations which are as follows:
a) lack of scalability (both in terms of users and number of services),
b) single point of failure,
c) large number of queries between load balancer and services for resource lookup and update queries,
d) 3 leads to high cost of communication between balancer and server, and/or
e) extra round trip time is needed for the redirection of requests, which is similar in Web based services, with a centralized request handler that uses algorithms like round-robin to forward a request to a particular service, wherein casting from a logical service URL to one among a pool of IP addresses is heavily used as, similarly, URL redirection used in other cases.

Embodiments of the present invention are focused on designing a new Internet architecture in order to solve problems of the current design while making it future-proof. In contrast to traditional IP, the present invention focuses on content rather than on establishing communication pipes between end-systems hosting that content. This reliance on names enables it to route to content and services without having to associate a location-dependent address to them. Additionally, embodiments of the present invention inherently can support multicast, anycast, caching and locating content and services without having to rely on DNS (DNS=Domain Name Service), which makes the present invention a viable alternative to the current methods of locating content and services. Therefore, embodiments of the present invention provide a SCN scheme (SCN=Service-Centric Networking) that leverages CCN to route interests to the best instance of a requested service.

In order to make knowledgeable decisions on service instance selection and routing, the dissemination of information about newly instantiated services, constantly changing node resources and service and content properties is imperative. These requirements are fulfilled by the embodiments of the present invention which make use of ACO concepts or concepts based on ACO to gather and disseminate information and enable thereby to make informed decisions on service selection and instantiation. Embodiments of the present invention may therefore be regarded as an implementation of SCN as a control layer over CCN to route interests to the right service. Preferably, the inventive scheme does not change the CCN layer functionality. The network nodes or routers can run the CCN routing protocol which is used to route requests to services and back.

Embodiments can furthermore advantageously provide following features:
i) routers can balance load in a distributed way, since the routing is service or named based,
ii) routing decisions, i.e. the evaluation and calculation of the service performance data, can be made depending on different metrics, taking into account requirements of a service or content,
iii) routing decisions, i.e. the evaluation and calculation of the service performance data, can be made independently from service requests, which allows the routers to forward requests in the fast path, i.e. by fast path controlling, and in line speed,
iv) caching and location independent names, i.e. service performance data and server location, can enable mobility,
v) multicasting can be provided, since content adaptation and/or services can be installed on an intermediate node or router in the communication is network such that a single copy of content is sent from a content server to the service before being sent to multiple clients after adaptation, which can reduce overhead caused by transporting multiple copies of adapted content to different clients,
vi) optimal service selection (anycast) can be provided, since embodiments of the present invention can forward a request to the best service based on a metric, like closest service, lightly loaded service, etc.,
vii) since current NBR layers are using latency as the only metric for optimized content delivery, embodiments of the present invention can include additional metrics, such as bandwidth, service bad, etc. which is an advantage over CCN,
vii) embodiments of the present invention may not require service lookup and resolution, since in contrast to traditional services, a service instantiation can result in a publish step where all the nodes in the communication network get notified about the service by means of an availability message, and furthermore, the absence of a resolution step because of name-based routing results in lower delays, and/or
viii) embodiments of the present invention can provide service data caching or service performance data caching, since routers can cache service content, and therefore, other clients requesting the same processed content can be sent the cached version of the content which can reduce the overhead of transporting popular content.

Further advantages are achieved by embodiments of the invention indicated by the dependent claims.

According to a preferred embodiment of the invention the method for service named routing the first router and/or the second router attaches, preferably by means of a control unit, timestamp data indicating the time of the arrival or forwarding of the interest packet to the interest packet. The first router and/or the second router calculates, preferably by means of the control unit, delay time data being part of the service performance data associated with interest packet by means of the interest tag in the service performance table based on the local time or reception time of the interest packet at the first router and/or second router, respectively and the respective timestamp data previously attached to the interest packet by the first router and/or second router, respectively.

According to a preferred embodiment of the invention the method for service named routing the server and/or the second router , preferably by means of a control unit, attaches bandwidth data to the interest packet. The second router, preferably by means of its control unit, and/or the first router, preferably by means of a control unit, compares the bandwidth data stored in the interest packet with the local bandwidth data associated with the incoming and/or outgoing connection port and replacing the bandwidth data by the local bandwidth data in case that the local bandwidth is smaller than the bandwidth stored. The second router and/or the first router, preferably by means of the control unit, uses the local bandwidth data and for the bandwidth data stored in the interest packet to calculate the service performance data associated with interest packet by means of the interest tag in the service performance table.

It is possible, the routing data comprises a load data of the at least two servers, is bandwidth data associated with the connection to the at least one service and delay time data associated with the connection to the at least one service, rating data associated with the connection to the at least one service, and probability data associated with the rating data.

Preferably, the first router and/or the second router, by means of a control unit replaces the correspondingly stored bandwidth data, the delay time data and the load data of the at least one server with the bandwidth data of the received interest packet.

It is possible that the probability associated with a service of the at least one service and with a connection port associated with the at least one service and/or with a neighboring router of the at least two servers and/or of a router of the plurality of routers is the associated rating divided by the sum of all ratings associated with the at least one service irrespective of the connection port.

According to a preferred embodiment of the invention the method for service named routing the first router and/or the second router, preferably by means of a control unit, reduces a result of the calculation of the service performance data calculation, preferably periodically every 1 minute to 10 minutes, by multiplication of a factor. The factor is preferably a number between 0 and 1. A suitable value of the factor can be equal to 0.9.

According to a preferred embodiment of the invention the method for service named routing the at least two servers, preferably by means of a control unit, send an availability message of the at least one service to neighboring routers of the plurality of routers. A router of the plurality of routers, preferably by means of a control unit, forwards the availability message to neighboring routers of the plurality of routers when the router receives the availability message.

Preferably, the router of the plurality of routers, preferably by means of the control unit, forwards the availability message to neighboring routers of the plurality of routers when the router receives the availability message the first time.

According to a preferred embodiment of the invention the method for service named routing each router, preferably by means of a control unit, restarts the method with the step of sending to two or more neighboring routers via two or more of its connection ports an interest packet associated with the at least one service comprising a service name indicator and a unique interest tag for a randomly selected service from at least one service periodically within a predefined time period.

According to a preferred embodiment of the invention the method for service named routing the second router, preferably by means of a control unit, checks whether there is a corresponding outgoing connection port listed in its interest rout table and/or routing table of the router for sending the interest packet via an outgoing connection port associated with the at least one service. In case there is no corresponding outgoing connection port listed then the second router, preferably by means of the control unit, starts the method with the step of sending, by the second router, to two or more neighboring routers via two or more of its connection ports an interest packet associated with the at least one service comprising a service name indicator and a unique interest tag.

According to a preferred embodiment of the invention the method for service named routing each router of the plurality or routers, preferably by means of a control unit, routes communication packets according to the routing table of the router by means of fast path controlling.

According to a preferred embodiment of the invention the router for service named routing the routing table is part of the fast path controlling.

It is possible that the two or more connection ports comprise at least one incoming connection port and at least one outgoing connection port for routing interest packets and/or communication packets by means of fast path controlling.

Preferably, one or more of the two or more connection ports act as or provide the functionality of an incoming connection port and an outgoing connection.

Control of the fast path layer resides above the named routing layer. These layers can be layers according to the Open Systems Interconnection model (OSI=Open Systems Interconnection). Preferably, the fast path resides at the second layer and/or third layer, i.e. data link layer and/or the network layer, respectively, of the OSI model.

According to a preferred embodiment of the invention the method for service named routing the first router, preferably by means of a control unit, receives the interest packet via the outgoing connection port associated with the interest tag stored in the interest route table of the first router. The first router, preferably by means of the control unit, calculates service performance data based on the data attached to the interest packet, stores the service performance data in the service performance table of the first router and updates the routing table of the first router based on an evaluation of the service performance data stored in the service performance table of the first router.

According to a preferred embodiment of the invention the method for service named routing the first router and/or the second router, preferably by means of a control unit, stores rating data associated with result of the calculation of the service performance data calculation in its service performance table being inversely proportional to the load data or load of the server and preferably being inversely proportional to delay time data or delay time and/or proportional to bandwidth data or bandwidth associated with the at least one service. The first router and/or the second router, preferably by means of the control unit, calculates probability data for each outgoing connection port associated with the at least one service based on the rating data. The first router and/or the second router, preferably by means of the control unit, updates the routing table by means of storing the at least one connection port associated with the at least one service having a maximum probability.

Preferably, each router, preferably by means of a control unit, stores in its routing table for each service of the at least one service at least one connection port associated with the at least one service and/or with a neighboring router of the at least two servers and/or of a router of the plurality of routers for routing data packets of each service of the at least one service via an associated connection port to the respective at least one service and/or the respective neighboring router of the at least two servers and/or of a router of the plurality of routers.

It is possible, that a neighboring router of the at least one server and/or of a router of the plurality of routers is connected to the at least two servers and/or to the router of the plurality of routers, respectively without having another router of the plurality of routers in between the connection from the neighboring router to the at least two servers and/or to the router of the plurality of routers, respectively.

Preferably, each router, preferably by means of a control unit, stores in its service performance table for each service of the at least one service and for each connection port associated with the at least two servers and/or with a neighboring router of the at least two servers and/or of a router of the plurality of routers routing data.

It is possible that the second router of the plurality of routers is a neighboring router of the first router of the plurality of routers.

Preferably, the incoming connection port is the connection port by which the interest packet was received. The outgoing connection port can be the connection port at which the interest packet is sent off.

It is possible that the incoming connection port is a connection port of the router at which the interest packet was received at the first time and the outgoing connection port is a connection port of the router at which the interest packet was sent off at the first time.

Preferably, the interest packet is named or called routing instillation packet. The interest packet can be named or called data packet while the interest packet is send back from the server to the first router.

It is possible that the at least one storage unit is a memory device or data base holding the routing table, the service performance table and/or the interest route table.

Preferably, the service performance data comprises one or more of the following routing specific data: the number of hops along one routing path of the interest data packet, the minimum of available bandwidth on the links along routing path of the interest data packet, administrative costs along one routing path of the interest data packet and a transit delay on the links along the path of the interest data packet. A link may be the connection between two neighboring routers of the plurality of routers.

These as well as further features and advantages of the invention will be better appreciated by reading the following detailed description of presently preferred exemplary embodiments taken with the accompanying drawing of:

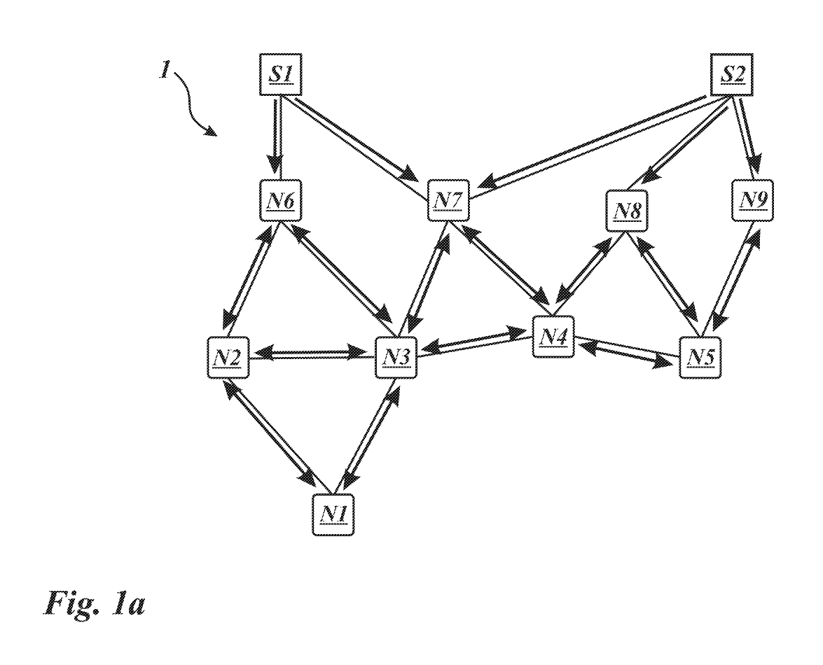

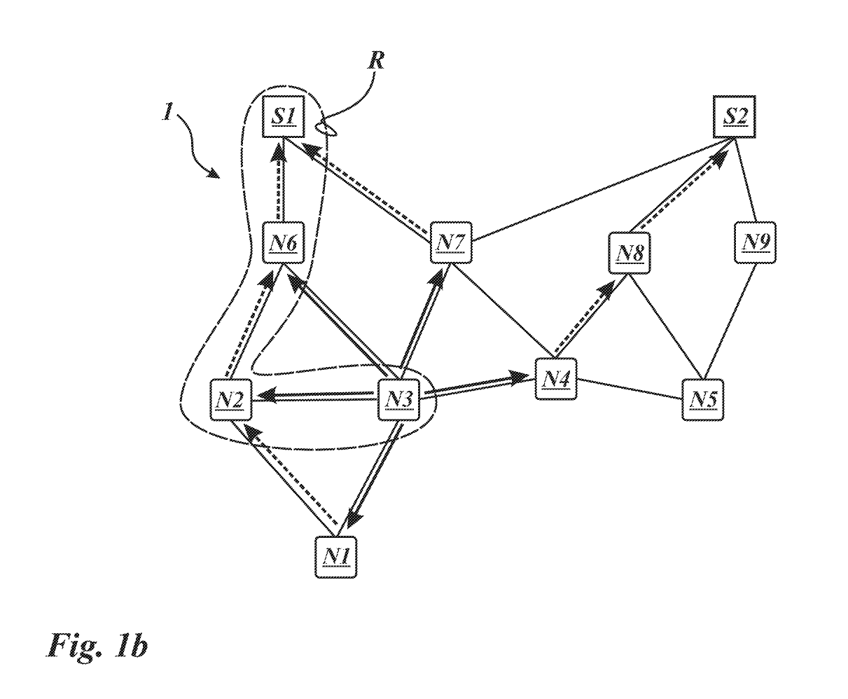

FIGS. 1a, 1b, 1c show a packet based communication network comprising two servers providing at least one service and nine routers during the different method steps of the method for service named routing in accordance with the present invention.

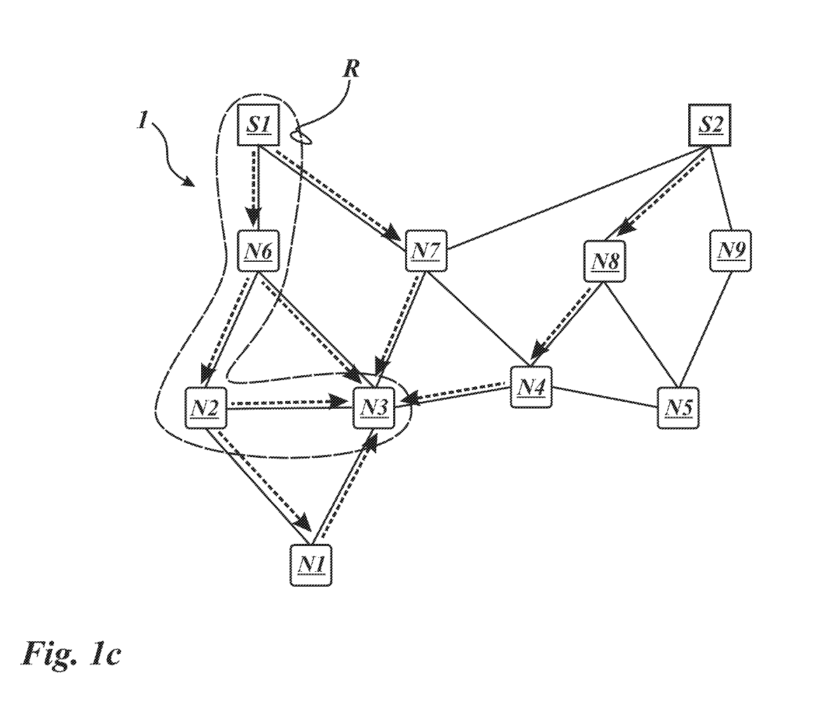

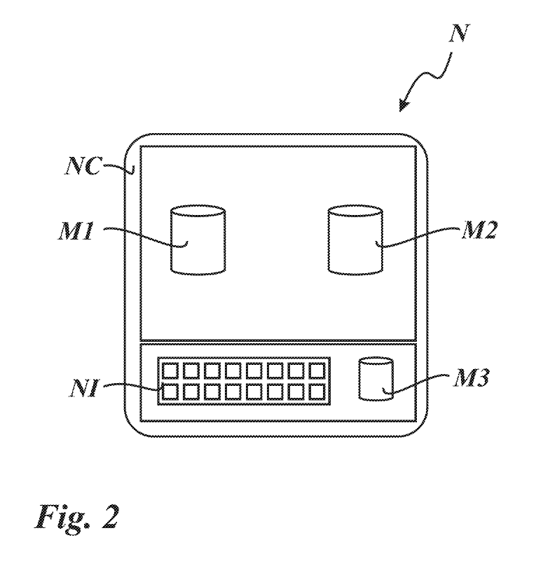

FIG. 2 shows router for service named routing in accordance with the present invention.

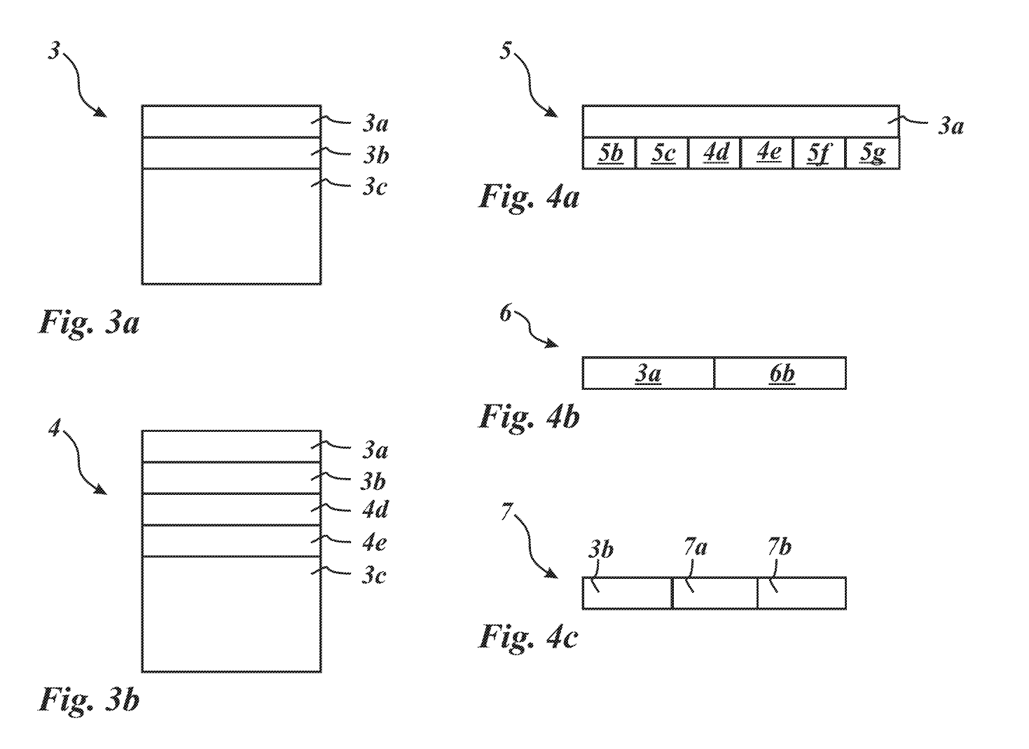

FIG. 3a shows a data structure of the interest packet while being routed from a first router towards a server providing the at least one service in accordance with the present invention.

FIG. 3b shows a data structure of the interest packet while being routed backwards from the server providing the at least one service to a first router in accordance with the present invention.

FIG. 4a shows a service performance table in accordance with the present invention.

FIG. 4b shows a routing table in accordance with the present invention.

FIG. 4c shows an interest route table in accordance with the present invention.

FIGS. 1a, 1b, 1c show a packet based communication network 1 comprising two servers S1, S2 providing at least one service and nine routers N1, . . . , N9 during the different method steps of the method for service named routing in accordance with the present invention. These routers N1, . . . , N9 are in accordance with the present invention. Direct connections between the routers N1, . . . , N9 and/or servers S1, S2 are shown by thin lines indicating network links and/or communication links and routing directions or travel directions of interest, data and/or communication packets between the routers N1, . . . , N9 and/or servers S1, S2 are shown by arrows. Direct connections between the routers N1, . . . , N9 and/or servers S1, S2 are connections without having a further router in between. A neighboring router of the at least one server S1, S2 and/or of a router of the plurality of routers N1, . . . , N9 is connected to the at least two servers S1, S2 and/or to the router of the plurality of routers N1, . . . , N9, respectively without having another router of the plurality of routers N1, . . . , N9 in between the connection from the neighboring router to the at least two servers Si, S2 and/or to the router of the plurality of routers N1, ..., N9, respectively.

Before describing further in detail the inventive method for service named routing the entities involved are described:

FIG. 2 shows a router N for service named routing in accordance with the present invention. The router N is corresponding to the routers N1, . . . , N9 shown in FIGS. 1a, 1b and 1c. However, the servers S1 and S2 can be routers of the communication network 1 and/or can provide in addition the functionality of the routers in accordance with the present invention. The router N comprises a control unit N, and three storage units M1, M2 and M3. The storage units M1, M2, and M3 hold an interest rout table 7, a service performance table 5 and a routing table 6, respectively. It is alternatively possible that the three storage units are provided by a single storage unit. A storage unit is a memory device, like a random access memory or a hard disk, or a data base entity by means of software and/or hardware means. The router N comprises further a network interface NI providing two or more connection ports which can act as incoming as well as outgoing connection ports. The router N routes communication packets according to the routing table 6 of the router N by means of fast path controlling, the control unit NC and the network interface NI. The routing table 6 is part of the fast path controlling.

In order to provide the service named routing in the packet based communication network 1. The servers S1 and S2 can publish the service to the routers N1, . . . , N9 by means of a respective availability message as depicted in FIG. 1a. Therefore the servers S1 and S2 can send the availability message to their neighboring routers N6, N7 and N7, N8, N9, respectively, indicated by single arrows in FIG. 1a. Preferably, only the first time a router receives the availability message the router forwards the availability messages to its neighboring routers, indicated by double arrows in FIG. 1a. However, each router may perform at least one time the inventive method.

Each router N1, . . . , N9 provides a routing table 6, a service performance table 5 and an interest route table 7. The structure of these tables is shown in the

FIGS. 4a, 4b, and 4c as follows:

FIG. 4a shows a service performance table 5 in accordance with the present invention. The service performance table 5 comprises for each service identified by a service name indicator 3a and for each connection port 5b of the respective router a load data 4d associated with the server of the at least two servers S1, S2 being reachable via the connection port 5b, a respective minimal bandwidth 4e of the routing path towards the server, a respective delay time 5c, a respective rating data 5f and a thereto associated probability 5g. However, it is also possible to use instead of these exemplary metrics, i.e. load of the server, bandwidth, and delay time one or more alternative metrics, e.g. the number of hops along the routing path or signal qualities like interference to noise ratios.

FIG. 4b shows a routing table 6 in accordance with the present invention. The routing table 6 comprises for each service the service name indicator 3a and an associated connection port 6b.

FIG. 4c shows an interest route table 7 in accordance with the present invention. The interest route table 7 comprises for each interest tag 3b an in incoming connection port 7a and an outgoing connection port 7b.

Each router N1, . . . , N9 stores in its routing table 6 for each service 3a at least one connection port 6b associated with the service 3a.

Each router N1, . . . , N9 stores in its service performance table 5 for each service of the at least one service service performance data associated with two or more connection ports of the router. The service performance data comprises for each service 3a and for each connection port 5b of the respective router the load data 4d associated with the server of the at least two servers S1, S2 being reachable via the connection port 5b, the respective minimal bandwidth 4e of the routing path towards the server, a respective delay time 5c, a respective rating data 5f and a thereto associated probability 5g.

A first router N3 sends to the neighboring routers N1, N2, N4, N6, N7 via its connection ports an interest packet associated with the service comprising a service name indicator 3a and a unique interest tag 3b as indicated in FIG. 1b by means of plain arrows.

FIG. 3a shows the data structure 3 of the interest packet while being routed along the route R as shown in FIG. 1b from a first router N3 towards the server S1 providing the at least one service. The interest packet comprises name indicator 3a and a unique interest tag 3b, and one or more timestamps, or timestamp data, 3c.

A second router N2 receives the interest packet via an incoming connection port, sends the interest packet via an outgoing connection port associated with the service 3a in its routing table 6 and stores the interest tag 3b of the received interest packet together with the incoming connection port and the outgoing connection port in its interest route table 7.

The server S1 receives via the route R—as indicated in FIG. 1b by means of the plain arrow and the dotted arrows—the interest packet through the routers N3, N2, and N6. The route R is only to be understood as an example, other possible routes are indicated in the FIGS. 1b and 1c by the dotted arrows.

The server S1 attaches data comprising load data of the at least one service to the interest packet as well as available bandwidth data and sends the interest packet back to the second router N2 via the routing path R as shown in FIG. 1c.

FIG. 3b shows a data structure 4 of the interest packet while being routed backwards from the server S1 providing the service to the first router N3. The interest packet comprises the service name indicator 3a and the unique interest tag 3b, and the timestamps attached by the routers N3, N2 and N6 as timestamp data 3c, and furthermore the load data 4d of the service at the server S1, and the bandwidth data 4e.

The second router N2 receives the interest packet and calculates service performance data based on the data attached to the interest packet. The second router N2 stores the service performance data in its service performance table 5 and updates its routing table 6 based on an evaluation of the service performance data stored in its service performance table 5 and sends the interest packet via the incoming connection port as associated by the interest route table 7 back along the route R to the first router N3. In other words, the interest packet is sent by along exactly the same routing path which it had marked by “breadcrumbs” on the route to the server S1.

The first router N3 receives the interest packet via the outgoing connection port associated with the interest tag 3b stored in its interest route table and calculates service performance data based on the data attached to the interest packet. The first router N3 stores the service performance data in its service performance table 5 and updates its routing table 6 based on an evaluation of the service performance data stored in its service performance table 5.

In more detail with respect to the attached data and the calculation and evaluation of the service performance data is as follows:

The second router N2, the first router N3 and the router N6—in the present example—attach their respective timestamp data indicating the time of the arrival or forwarding of the interest packet at the second router N2, the first router N3 and the router N6, respectively. The second router N2, the first router N3 and the router N6 calculate delay time data being part of the service performance data associated with interest packet by means of the interest tag 3b in their service performance table 5 based on the respective local time or reception time of the interest packet at the second router N2, the first router N3 and the router N6, respectively and the respective timestamp data previously attached to the interest packet by the second router N2, the first router N3 and the router N6, respectively.

Furthermore, the second router N2, and the server S1, and the router N6 attach their local bandwidth data, which is preferably associated with the connection and/or connection port, to the interest packet in case that there is no bandwidth data attached or the attached bandwidth data corresponds to bandwidth which is larger than the their respective local bandwidth. This is achieved by comparing the bandwidth data stored in the interest packet with the local bandwidth data associated with the incoming and/or outgoing connection port and replacing the bandwidth data in the interest packet by the local bandwidth data in case that the local bandwidth is smaller than the bandwidth stored. The service performance table 5 will correspondingly be updated in that case.

The second router N2, the first router N3 and the router N6 use the minimum of the local bandwidth and the bandwidth stored in the interest packet to calculate the service performance data associated with interest packet by means of the interest tag 3b in the service performance table 5.

The second router N2, the first router N3 and the router N6 store rating data associated with result of the calculation of the service performance data calculation in their service performance table 5. The rating data is inversely proportional to the load data of the server S1, inversely proportional to delay time data and proportional to bandwidth data associated with the service. The second router N2, the first router N3 and the router N6 calculate probability data for each outgoing connection port associated with the service based on the rating data. The probability associated with the service and with the connection port associated with the service is the associated rating divided by the sum of all ratings associated with the at least one service irrespective of the connection port. The second router N2, the first router N3 and the router N6 update their is routing table 6 by means of storing the at least one connection port associated with the at least one service having a maximum probability.

Each router reduces a result of its calculation of the service performance data calculation, preferably periodically every 1 minute to 10 minutes, by multiplication of a factor, wherein the factor is a number between 0 and 1, being preferably equal to 0.9.

Furthermore, each router N1, . . . , N9 restarts the method with the step of sending to two or more neighboring routers via its connection ports NI an interest packet for a randomly selected service from at least one service periodically with a predefined time period. Thereby the routing can be held optimal and up-to-date.

A router of the plurality of routers N1, . . . , N9 checks whether there is a corresponding outgoing connection port listed in its routing table 6 or interest route table 7 of the router for sending the interest packet via an outgoing connection port. In case there is no corresponding outgoing connection port listed then the router starts the method with the step of sending to its neighboring routers via its connection ports an interest packet associated with the at least one service comprising the service name indicator 3a and a unique interest tag 3b.

1. Method of service named routing in a packet based communication network, the communication network comprises at least two servers providing at least one service and a plurality of routers,
the method comprises:
providing, by each router of the plurality of routers, a routing table, a service performance table and an interest route table,
storing, by each router, in its routing table for each service of the at least one service at least one connection port associated with the at least one service,
storing, by each router, in its service performance table for each service of the at least one service performance data associated with two or more connection ports of the router,
sending, by a first router of the plurality of routers, to two or more neighboring routers via two or more of its connection ports an interest packet associated with the at least one service comprising a service name indicator and a unique interest tag,
receiving, by a second router of the plurality of routers, the interest packet via an incoming connection port, sending the interest packet via an outgoing connection port associated with the at least one service in its routing table and storing the interest tag of the received interest packet together with the incoming connection port and the outgoing connection port in its interest route table,
receiving, by a server of the at least two servers, the interest packet,
attaching, by the server, data comprising load data of the at least one service to the interest packet and sending the interest packet back to the second router,
receiving, by the second router the interest packet, and
calculating, by the second router, service performance data based on the data attached to the interest packet, storing the service performance data in the service performance table of the second router, updating the routing table of the second router based on an evaluation of the service performance data stored in the service performance table of the second router and
sending the interest packet via the incoming connection port as associated by the interest route table to the first router.

2. The method of service named routing according to claim 1, wherein the method comprises:
attaching, by the first router and/or by the second router, timestamp data indicating the time of the arrival or forwarding of the interest packet to the interest packet, and
calculating, by the first router and/or by the second router, delay time data being part of the service performance data associated with interest packet by means of the interest tag in the service performance table based on the local time or reception time of the interest packet at the first router and/or second router, respectively and the respective timestamp data previously attached to the interest packet by the first router and/or second router, respectively.

3. The method of service named routing according to claim 1, wherein the method comprises:
attaching, by the server and/or by the second router, service performance data to the interest packet,
comparing, by second router and/or by the first router, the service performance data stored in the interest packet with the local service performance data associated with the incoming and/or outgoing connection port and replacing the service performance data by the local service performance data in case that the local bandwidth is smaller than the bandwidth stored, and
using, by the second router and/or by the first router, the local service performance data and for the service performance data stored in the interest packet to calculate the service performance data associated with interest packet by means of the interest tag in the service performance table.

4. The method of service named routing according to claim 1, wherein the method comprises:
reducing, by the first router and/or by the second router, a result of the calculation of the service performance data calculation, preferably periodically every 1 minute to 10 minutes, by multiplication of a factor, wherein the factor is a number between 0 and 1, being preferably equal to 0.9.

5. The method of service named routing according to claim 1, wherein the method comprises:
sending, by the at least two servers, an availability message of the at least one service to neighboring routers of the plurality of routers and
forwarding, by a router of the plurality of routers the availability message to neighboring routers of the plurality of routers when the router receives the availability message.

6. The method of service named routing according to claim 1, wherein the method comprises:
restarting, by each router, the method with the step of sending to two or more neighboring routers via two or more of its connection ports an interest packet associated with the at least one service comprising a service name indicator and a unique interest tag for a randomly selected service from at least one service periodically within a predefined time period.

7. The method of service named routing according to claim 1, wherein the method comprises:
checking, by the second router whether there is a corresponding outgoing connection port listed in its interest route table and/or routing table of the router for sending the interest packet via an outgoing connection port associated with the at least one service, in case there is no corresponding outgoing connection port listed then starting, by the second router, the method with the step of sending, by the second router, to two or more neighboring routers via two or more of its connection ports interest packet associated with the at least one service comprising a service name indicator and a unique interest tag.

8. The method of service named routing according to claim 1, wherein the method comprises:
routing, by each router of the plurality or routers, communication packets according to the routing table of the router by means of fast path controlling.

9. The method of service named routing according to claim 1, wherein the method comprises:
receiving, by the first router, the interest packet via the outgoing connection port associated with the interest tag stored in the interest route table of the first router, and
calculating, by the first router, service performance data based on the data attached to the interest packet, storing the service performance data in the service performance table of the first router and updating the routing table of the first router based on an evaluation of the service performance data stored in the service performance table of the first router

10. The method of service named routing according to claim 1, wherein the method comprises:
storing, by the first router and/or by the second router, rating data associated with result of the calculation of the service performance data calculation in its service performance table being inversely proportional to the load data of the server and preferably being inversely proportional to delay time data and/or proportional to service performance data associated with the at least one service,
calculating, by the first router and/or by the second router, probability data for each outgoing connection port associated with the at least one service based on the rating data, and updating, by the first router and/or by the second router, the routing table by means of storing the at least one connection port associated with the at least one service having a maximum probability.

11. Router for service named routing in a packet based communication network comprising at least two servers providing at least one service and a plurality of routers, wherein the router comprises at least one storage unit storing a routing table, a service performance table which stores for each service of the at least one service service performance data associated with two or more connection ports of the router and an interest route table, a network interface comprising two or more connection ports and a control unit,
wherein said two or more connection ports and control unit are adapted to receive an interest packet, which was sent by another router of the plurality of routers, associated with the at least one service comprising a service name indicator and a unique interest tag via an incoming connection port, send the interest packet via an outgoing connection port associated with the at least one service in the routing table and store the interest tag of the received interest packet together with the incoming connection port and the outgoing connection port in the interest route table, to receive the interest packet comprising data, which comprises a load data of the at least one service, attached to the interest packet by the a server of the at least two servers via the outgoing connection port associated with the interest tag stored in the interest route table, to calculate service performance data based on the data attached to the interest packet, store the service performance data in the service performance table and update the routing table based on an evaluation of the service performance data stored in the service performance table, and to send the interest packet via the incoming connection port as associated by the interest route table to the other router.

12. The router for service named routing according to claim 1, wherein the routing table is part of the fast path controlling
